(19) United States
(12) Patent Application Publication
(10) Pub. No.: US 2024/0146633 A1
(43) Pub. Date: May 2, 2024

(54) SYSTEM, METHOD, DEVICE AND PROGRAM FOR MEASURING DELAY IN DEVICE

(71) Applicant: NIPPON TELEGRAPH AND TELEPHONE CORPORATION, Tokyo (JP)

(72) Inventors: Tatsuya FUKUI, Musashino-shi, Tokyo (JP); Toshihito FUJIWARA, Musashino-shi, Tokyo (JP); Ryota SHIINA, Musashino-shi, Tokyo (JP); Hiroya ONO, Musashino-shi, Tokyo (JP)

(73) Assignee: NIPPON TELEGRAPH AND TELEPHONE CORPORATION, Tokyo (JP)

(21) Appl. No.: 18/565,466

(22) PCT Filed: Jun. 25, 2021
(86) PCT No.: PCT/JP2021/024154

§ 371 Date: Nov. 29, 2023

(51) Int. Cl. H04L 43/0864; H04L 65/1059; H04L 65/80

(52) U.S. Cl. CPC H04L 43/0864; H04L 65/1059; H04L 65/80

(57) ABSTRACT

An object of the present disclosure is to measure a delay time occurring in a device that receives or outputs a video or an audio without requiring a special apparatus or precise inter-apparatus time synchronization.

According to the present disclosure, there is provided a system including: a remote apparatus connected to a device that executes processing of outputting or receiving data of a video or an audio via a communication network; and a user terminal that transmits and receives a signal to and from the remote apparatus via the communication network, in which the system performs, in the device and the remote apparatus, processing of outputting or receiving a video or an audio having a predetermined pattern, detects, in the user terminal or the remote apparatus, outputting or receiving of the video or the audio having the pattern, and calculates a delay time in the device by setting a timing at which outputting or receiving of the video or the audio having the pattern is detected as a reference and using timings at which the device and the remote apparatus transmit the data of the video or the audio having the pattern via the communication network.

### TECHNICAL FIELD

The present disclosure relates to a technique for measuring a delay time in a device that receives or outputs a video or an audio.

### BACKGROUND ART

With the spread of remote work, the importance of communication using a video and an audio is increasing. In order to smoothly advance communication using a video and an audio, it is important to shorten a video delay and an audio delay. For a video delay and an audio delay, not only a communication delay occurring in a network but also a device delay occurring in a device such as a camera, a microphone, a speaker, or a display need to be considered.

As a method of measuring the device delay, there is a measurement method utilizing an LED and an optical sensor (refer to, for example, Non Patent Literature 1). In this method, a delay time occurring in the camera can be measured by measuring a time difference between a time when the LED is turned on and a time when light is observed by the optical sensor by using an oscilloscope.

In order to use the technique described in Non Patent Literature 1, dedicated devices such as an LED, an optical sensor, and an oscilloscope for measurement are required. For this reason, it is not realistic to widely implement the technique.

### CITATION LIST

### Non Patent Literature

Non Patent Literature 1: “2. Measuring Delay Time”, Technologies, Optical Path Communications that connect high definition images by optical technology, https://h-path.co.jp/technologies/2-how-to-measure-latency/

### Summary of Invention

### Technical Problem

An object of the present disclosure is to measure a delay time occurring in a device that receives or outputs a video or an audio without requiring a special apparatus or precise inter-apparatus time synchronization.

### Solution to Problem

According to the present disclosure, there is provided a system including:
a remote apparatus connected to a device that executes processing of outputting or receiving data of a video or an audio via a communication network; and a user terminal that transmits and receives a signal to and from the remote apparatus via the communication network,
in which the system performs, in the device and the remote apparatus, processing of outputting or receiving a video or an audio having a predetermined pattern,
detects, in the user terminal or the remote apparatus, outputting or receiving of the video or the audio having the pattern, and
calculates a delay time in the device by setting a timing at which outputting or receiving of the video or the audio having the pattern is detected as a reference and using timings at which the device and the remote apparatus transmit the data of the video or the audio having the pattern via the communication network.

According to the present disclosure, there is provided a method for a system including a remote apparatus connected to a device that executes processing of outputting or receiving data of a video or an audio via a communication network and a user terminal that transmits and receives a signal to and from the remote apparatus via the communication network,
the method including:
performing, in the device and the remote apparatus, processing of outputting or receiving a video or an audio having a predetermined pattern;
detecting, in the user terminal or the remote apparatus, outputting or receiving of the video or the audio having the pattern; and
calculating a delay time in the device by setting a timing at which outputting or receiving of the video or the audio having the pattern is detected as a reference and using timings at which the device and the remote apparatus transmit the data of the video or the audio having the pattern via the communication network.

According to the present disclosure, there is provided an apparatus included in a system including a remote apparatus connected to a device that executes processing of outputting or receiving data of a video or an audio via a communication network and a user terminal that transmits and receives a signal to and from the remote apparatus via the communication network, the apparatus functioning as the user terminal,
in which processing of outputting or receiving a video or an audio having a predetermined pattern is performed in the device and the remote apparatus, and
in a case where outputting or receiving of the video or the audio having the pattern is detected in the user terminal or the remote apparatus,
the apparatus calculates a delay time in the device by setting a timing at which outputting or receiving of the video or the audio having the pattern is detected as a reference and using timings at which the device and the remote apparatus transmit the data of the video or the audio having the pattern via the communication network.

The apparatus according to the present disclosure can also be implemented by a computer and a program, and the program can be provided by being recorded in a recording medium or via a network.

### Advantageous Effects of Invention

According to the present disclosure, it is possible to measure a delay time occurring in a video device without requiring a special apparatus or precise inter-apparatus time synchronization.

### BRIEF DESCRIPTION OF DRAWINGS

FIG. 1 illustrates a configuration example of a system according to an embodiment of the present disclosure.

FIG. 2 illustrates a configuration example of a system according to an embodiment of the present disclosure.

FIG. 3 illustrates an example of a delay database.

FIG. 4 illustrates an example of functions of a user terminal.

FIG. 5 illustrates a configuration example of a system according to an embodiment of the present disclosure.

FIG. 6 illustrates a configuration example of a system according to an embodiment of the present disclosure.

FIG. 7 illustrates an example of a delay database.

FIG. 8 illustrates an example of functions of a user terminal.

### DESCRIPTION OF EMBODIMENTS

Hereinafter, embodiments of the present disclosure will be described in detail with reference to the drawings. Note that the present disclosure is not limited to the embodiments described below. These examples are merely examples, and the present disclosure can be carried out in a form with various modifications and improvements based on the knowledge of those skilled in the art. Note that components having the same reference numerals in the present specification and the drawings denote the same components.

A delay time in a communication network can be measured. Therefore, the present disclosure includes a remote apparatus connected to a device that executes processing of receiving or outputting data of a video or an audio via a communication network. In addition, by causing the device to respond via the communication network and subtracting a delay time in the communication network from a response time of the device via the communication network, the response time of the device alone can be measured in a user terminal.

In the present disclosure, the device is any device that executes processing of receiving or outputting media data of a video or an audio, and is, for example, a camera, a monitor, a microphone, or a speaker. The camera converts a video into video data and outputs the video data. The monitor receives video data, and outputs a video. The microphone converts an audio into audio data, and outputs the audio data. The speaker receives audio data, and outputs an audio. In the present disclosure, a method for measuring a response time of a device alone in a case where media data is video data will be described.

In the present disclosure, processing of outputting or receiving a video having a predetermined pattern is performed in the device and the remote apparatus,
outputting or receiving of the video having the pattern is detected in the user terminal or the remote apparatus, and
a delay time in the device is calculated by setting a timing at which outputting or receiving of the video is detected as a reference and using timings at which the device and the remote apparatus transmit data of the video having the pattern via the communication network.

For example, in a case where the device is a camera, the camera and a response apparatus are connected to each other via a communication network. In this state, a screen of the user terminal is changed in a predetermined pattern, a change in the screen is imaged by the camera, and a response from the response apparatus is received by the user terminal. The user terminal detects a timing when the screen is changed in the pattern. In addition, the user terminal measures a time from when the received screen is changed to when the response signal is received, and subtracts the delay time in the communication network from the measured time. Thereby, the user terminal can measure a delay time in the camera.

For example, in a case where the device is a display, the display and a control apparatus are connected to each other via a communication network. In this state, a request signal is transmitted from the user terminal to the control apparatus, and a video on the display is changed in a predetermined pattern. The user terminal detects a change in the pattern of the video on the display. In addition, the user terminal measures a time from when the request signal is transmitted to when the video on the display is changed, and subtracts a delay time in the communication network from the measured time. Thereby, the user terminal can measure a delay time in the display.

The video data is any data that can be processed by the device, and is, for example, a high-definition multimedia interface (HDMI, HDMI is a registered trademark) signal. Hereinafter, an example in which the video data is an HDMI signal will be described in detail.

### First Embodiment

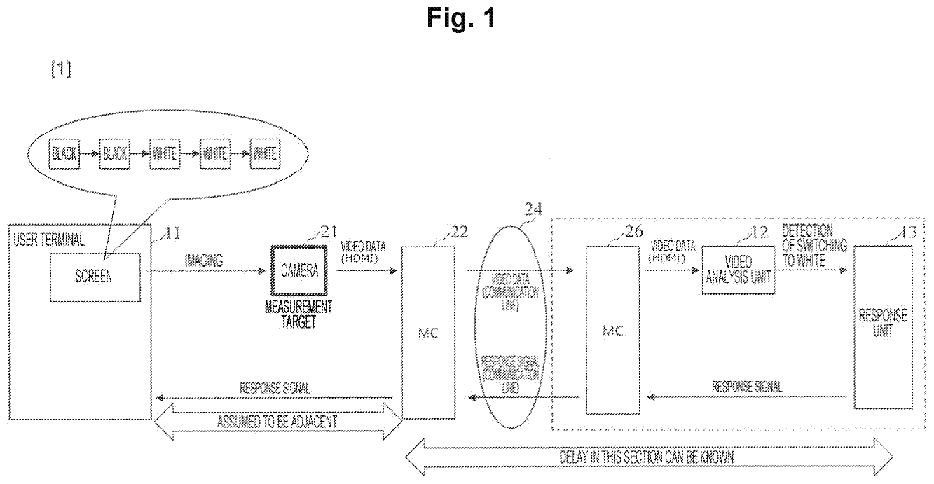

FIG. 1 illustrates a configuration example of a system according to the present embodiment. A video delay measurement system according to the present embodiment includes a user terminal 11, a camera 21 as a measurement target device, a video analysis unit 12, and a response unit 13. The user terminal 11 includes an application that measures a delay time of an HDMI signal which is output from the camera 21.

The camera 21 is connected to the video analysis unit 12 and the response unit 13 via a communication network 24. In the present embodiment, media converters (MC) 22 and 26 for transmitting an HDMI signal from the camera 21 via the communication network 24 are provided.

A video delay measurement system according to the present embodiment executes the following steps.

S101: A delay time T_{N} of the communication network 24 is measured in advance using Ping or the like.

S102: The user terminal 11 displays a predetermined video pattern on a screen. The video pattern is a certain video of which a change on a screen can be detected by the video analysis unit 12. The camera 21 captures an image of a screen in a changing state. The HDMI signal from the camera 21 is transmitted by using the MCs 22 and 26 via the communication network 24.

S103: The video analysis unit 12 acquires the HDMI signal from the MC 26, and issues a signal to the response unit 13 at a timing when white is detected. Thereby, the communication network 24 detects a change on the screen.

S104: In a case where the signal from the video analysis unit 12 is received, the response unit 13 returns a response signal. A transmission destination of the response signal can be set to a certain destination, and is, for example, the user terminal 11.

S105: The user terminal 11 measures a round-trip time from when the screen is changed to when a response signal is received, and measures a delay in the camera 21 by using the round-trip time. For example, the delay in the camera 21 is measured by subtracting the delay time T_{N} in the communication network 24 from the round-trip time.

In step S102, the user terminal 11 displays a screen under a control of the measurement application. For example, the video pattern is a video pattern in which screen display is switched in order of black, black, white, white, and white in a certain period of time. The response unit 13 detects the pattern in which screen display is switched in order of black, black, white, white, and white, and generates a response signal at a time when screen display is switched from black to white.

Further, in step S104, the response unit 13 may transmit the time when the signal from the video analysis unit 12 is received to the user terminal 11 using the response signal. In this case, in step S105, the user terminal 11 measures the delay in the camera 21 by using the time from when the video pattern is displayed on the screen to the time when the response signal is notified instead of the round-trip time from when the screen is changed to when the response signal is received.

In the present embodiment, an example in which the measurement target of the delay time is the camera 21 is described. On the other hand, the present disclosure is not limited thereto. For example, a microphone may be used instead of the camera 21. In this case, an audio analysis unit is provided instead of the video analysis unit 12. In addition, the user terminal 11 may change an output audio in step S102, the microphone may output audio data in step S103, and the audio analysis unit may detect a change in the audio in step S104.

### Second Embodiment

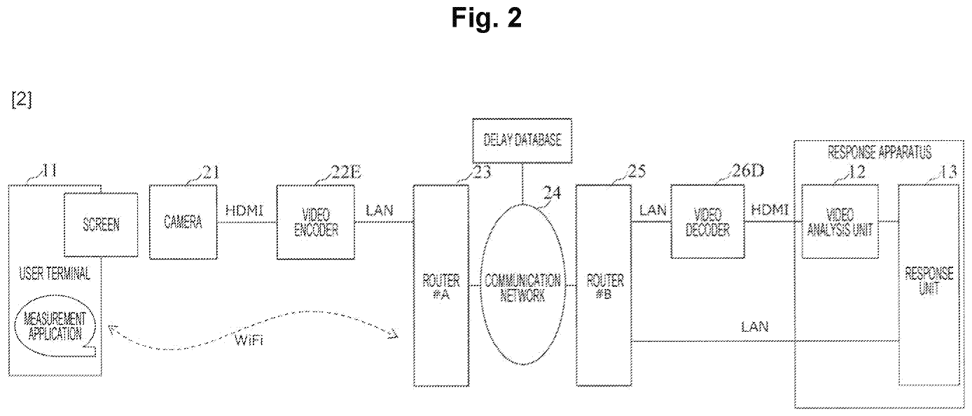

FIG. 2 illustrates a configuration example of a system according to the present embodiment. A video delay measurement system according to the present embodiment includes a video encoder 22E as the MC 22, a video decoder 26D as the MC 26, and a delay database in which a delay time in the communication network 24 is recorded, the video encoder 22E being connected to the communication network 24 by a router 23, and the video decoder 26D being connected to the communication network 24 by a router 25. Further, the video analysis unit 12 and the response unit 13 are provided in a response apparatus.

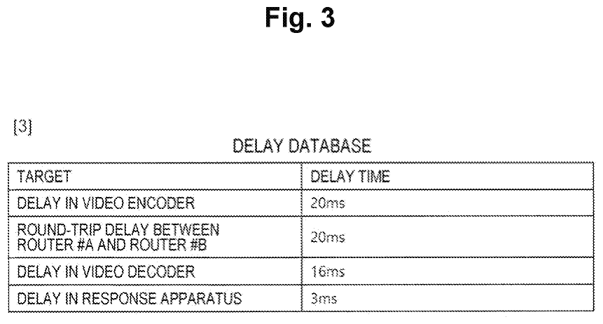

FIG. 3 illustrates an example of the delay database. The delay database stores a delay time T_{N} between the routers 23 and 25, a delay time T_{E} in the video encoder 22E, a delay time T_{E} in the video decoder 26D, and a delay time T_{R} in the response apparatus.

The HDMI signal from the camera 21 is input to the video encoder 22E using an HDMI cable. The video encoder 22E converts the HDMI signal into a format that can be transmitted via the communication network 24. For example, the HDMI signal is converted into an IP packet. Thereby, the HDMI signal from the video encoder 22E is input to the router 23 via a LAN, is transmitted from the router 23 to the router 25 via the communication network 24, and is input from the router 25 to the video decoder 26D via a LAN.

The video decoder 26D converts the IP packet into an HDMI signal, and outputs the HDMI signal to the video analysis unit 12. The video analysis unit 12 detects that screen display is switched from black to white by using the HDMI signal. In a case where the video analysis unit 12 detects that screen display is switched from black to white, the response unit 13 transmits a response signal to the router 25 at that timing. The router 25 transmits the response signal to the router 23, and the router 23 transmits the response signal to the user terminal 11. Here, the response signal does not include a video signal, and thus any data transmission method can be used. For example, a LAN can be used between the response unit 13 and the router 25, and a wireless LAN such as WiFi can be used between the router 23 and the user terminal 11.

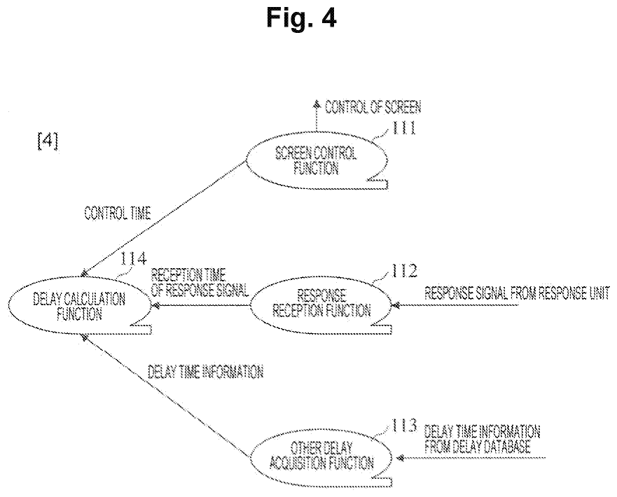

FIG. 4 illustrates an example of functions of the user terminal 11. The application included in the user terminal 11 has a screen control function 111, a response reception function 112, an other delay acquisition function 113, and a delay calculation function 114.

The screen control function 111 performs a certain display that can be detected by the video analysis unit 12, and notifies the user of a timing when the display is performed as a control timing. As the display, for example, the screen display is switched in order of black, black, white, white, and white in a certain period of time.

The response reception function 112 receives a response signal from the response unit 13, and notifies the delay calculation function 114 of the timing when the response signal is received.

The other delay acquisition function 113 acquires delay time information from the delay database, and notifies the delay calculation function 114 of the delay time information.

The delay calculation function 114 subtracts the delay time acquired by the other delay acquisition function 113 from the timing when the response signal is received, and obtains a delay time in the camera 21.

### Third Embodiment

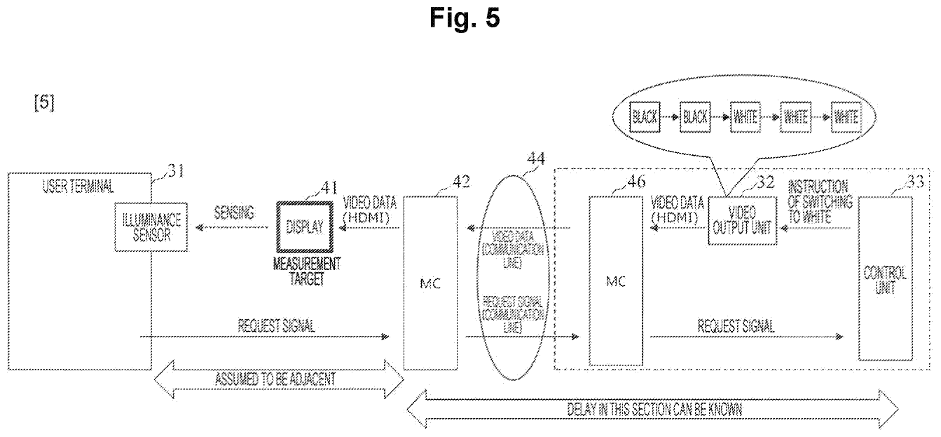

FIG. 5 illustrates a configuration example of a system according to the present embodiment. A video delay measurement system according to the present embodiment includes a user terminal 31, a display 41 as a measurement target, a video output unit 32, and a control unit 33. The user terminal 11 includes an illuminance sensor that detects display on the display 41 and an application that measures a time from transmission of a request signal for changing an output video to detection of an illuminance change.

The display 41 is connected to the video output unit 32 and the control unit 33 via a communication network 44. In the present embodiment, media converters (MC) 46 and 42 for transmitting an HDMI signal from the video output unit 32 via the communication network 44 are provided.

A video delay measurement system according to the present embodiment executes the following steps.

S201: A delay time T_{N} of the network 44 is measured in advance using Ping or the like.

S202: The user terminal 11 transmits a request signal for changing the output video.

S203: In a case where the request signal is received, the video output unit 32 outputs an HDMI signal for changing the output video. The HDMI signal from the video output unit 32 is transmitted by using the MCs 46 and 42 via the communication network 44.

S204: The display 41 acquires and displays the HDMI signal from the MC 42.

S205: The user terminal 31 detects a change in the video on the display 41, the change being occurred over the network. In addition, the user terminal 31 measures a time from the transmission of the request signal to the detection of the change in the video on the display 41, and measures a delay time of the display 41 using the time.

In step S203, the video output unit 32 outputs a video of which the screen display is switched to white under a control of the control unit 33. For example, the video output unit 32 outputs an HDMI signal of which the screen display is switched in order of black, black, white, white, and white in a certain period of time. Thereby, in step S203, a video of which the screen display is switched in order of black, black, white, white, and white in a certain period of time is displayed on the display 41.

In the present embodiment, an example in which the measurement target of the delay time is the display 41 is described. On the other hand, the present disclosure is not limited thereto. For example, a speaker may be used instead of the display 41. In this case, an audio output unit is provided instead of the video output unit 32. In addition, the audio output unit may change an output audio in step S203, the speaker may output audio data in step S204, and the user terminal 31 may detect a change in the audio in step S205.

### Fourth Embodiment

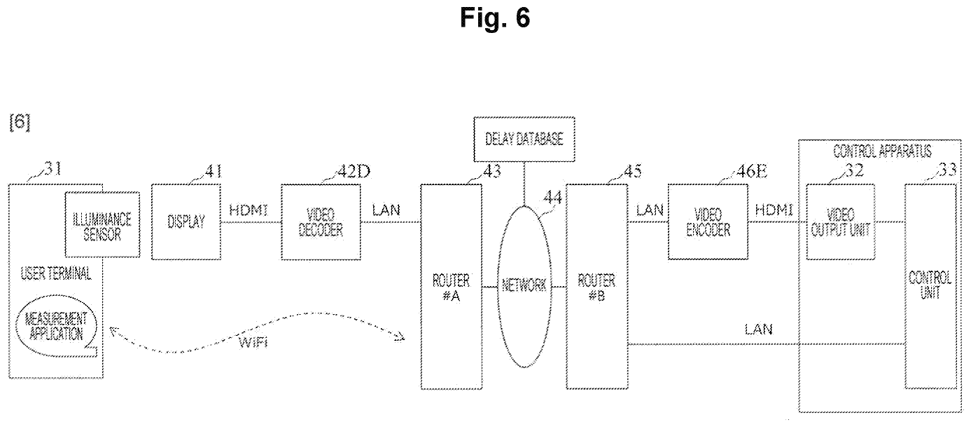

FIG. 6 illustrates a configuration example of a system according to the present embodiment. A video delay measurement system according to the present embodiment includes a video encoder 46E as the MC 46, a video decoder 42D as the MC 42, and a delay database in which a delay time in the communication network 44 is recorded, the video encoder 46E being connected to the communication network 44 by a router 45, and the video decoder 42D being connected to the communication network 44 by a router 43. Further, the video output unit 32 and the control unit 33 are provided in a control apparatus.

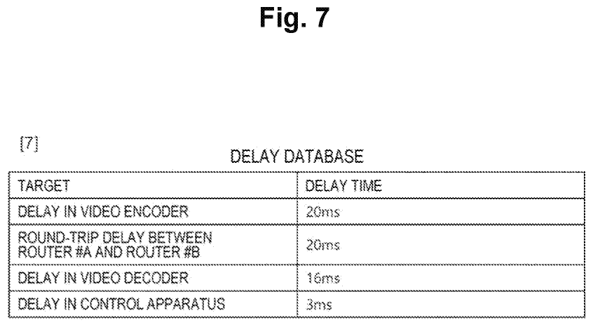

FIG. 7 illustrates an example of the delay database. The delay database stores a delay time T_{N} between the routers 43 and 45, a delay time T_{E} in the video encoder 46E, a delay time T_{D} in the video decoder 42D, and a delay time T_{C} in the control apparatus.

The video encoder 46E converts the HDMI signal into a format that can be transmitted via the communication network 44. Thereby, the HDMI signal from the video encoder 46E is input to the router 45 via a LAN, is transmitted from the router 45 to the router 43 via the communication network 44, and is input from the router 43 to the video decoder 42D via a LAN.

The video decoder 42D converts the format that can be transmitted via the communication network 44 into an HDMI signal, and outputs the HDMI signal to the display 41. The display 41 displays a video of which the screen display is switched in order of black, black, white, white, and white in a certain period of time. The user terminal 31 detects a change in the video on the display 41, the change being occurred via the communication network 44.

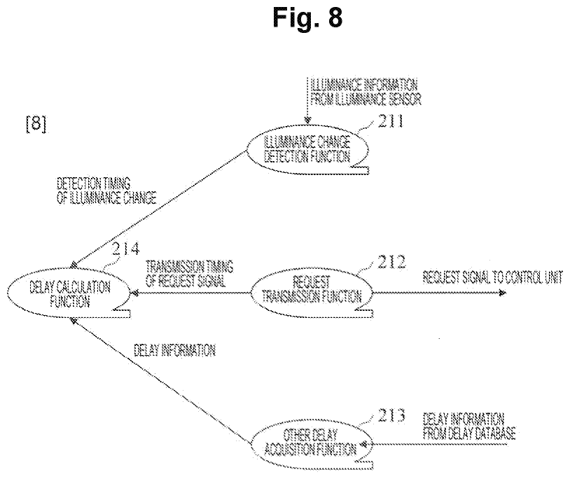

FIG. 8 illustrates an example of functions of the user terminal 31. The application included in the user terminal 31 has an illuminance change detection function 211, a request transmission function 212, an other delay acquisition function 213, and a delay calculation function 214.

The illuminance change detection function 211 acquires illuminance information from the illuminance sensor, detects that the illuminance is switched from black to white, and notifies the delay calculation function 214 of a timing when the illuminance change is detected.

The request transmission function 212 transmits a request signal to the control unit 33, and notifies the delay calculation function 214 of a transmission timing of the request signal.

The other delay acquisition function 213 acquires delay time information from the delay database, and notifies the delay calculation function 214 of the delay time information.

The delay calculation function 214 obtains a delay in the display 41 from the timing when the illuminance change is detected, using the timing when the request signal is transmitted and the delay time information acquired by the other delay acquisition function 213.

### (Effects of Present Disclosure)

According to the present disclosure, the user terminal 11 can measure a delay occurring in a device such as the camera 21 or the display 41 without requiring a special apparatus or precise inter-apparatus time synchronization.

In the above-described embodiments, an example in which the measurement target of the delay time is the camera 21 or the display 41 is described. On the other hand, the present disclosure is not limited thereto. For example, a microphone may be used instead of the camera 21, a speaker may be used instead of the display 41, or a combination thereof may be used.

In addition, an example in which the remote apparatus is the response apparatus or the control apparatus is described. On the other hand, the remote apparatus may have both a response function corresponding to the response apparatus and a control function corresponding to the control apparatus.

Furthermore, in addition to the applications included in the user terminals 11 and 31, certain functions of the camera 21, the video analysis unit 12, the response unit 13, the MCs 22, 26, 42, and 46, the video encoders 22E and 46E, the video decoders 26D and 42D, the display 41, the video output unit 32, and the control unit 33 can also be realized by a computer and a program, and the program can be provided by being recorded in a recording medium or via a certain communication network.

### INDUSTRIAL APPLICABILITY

The present disclosure can be applied to information and communication industries.

### REFERENCE SIGNS LIST

11, 31 User terminal
12 Video analysis unit
13 Response unit
21 Camera
22, 26, 42, 46 MC
22E, 46E Video encoder
23, 25, 43, 45 Router
26D, 42D Video decoder
24, 44 Communication network
32 Video output unit
33 Control unit
41 Display
111 Screen control function
112 Response reception function
113 Other delay acquisition function
114 Delay calculation function
211 Illuminance change detection function
212 Request transmission function
213 Other delay acquisition function
214 Delay calculation function

1. A system comprising:
a remote apparatus connected to a device that executes processing of outputting or receiving data of a video or an audio via a communication network; and a user terminal that transmits and receives a signal to and from the remote apparatus via the communication network,
wherein the system performs, in the device and the remote apparatus, processing of outputting or receiving a video or an audio having a predetermined pattern,
detects, in the user terminal or the remote apparatus, outputting or receiving of the video or the audio having the pattern, and
calculates a delay time in the device by setting a timing at which outputting or receiving of the video or the audio having the pattern is detected as a reference and using timings at which the device and the remote apparatus transmit the data of the video or the audio having the pattern via the communication network.

2. The system according to claim 1,
wherein the device has a function of converting a video or an audio into media data and outputting the media data,
the remote apparatus has a response function of detecting a change in the video or the audio having the pattern from the media data,
the system outputs the video or the audio having the pattern in the user terminal,
converts the video or the audio having the pattern into media data in the device,
transmits the media data to the remote apparatus via the communication network,
transmits a response signal to the user terminal in accordance with the change in the media data in the remote apparatus,
measures a time from when the user terminal outputs the video or the audio having the pattern to when the user terminal receives the response signal, and
measures a delay in the device by using the measured time.

3. The system according to claim 1,
wherein the device has a function of outputting a video or an audio according to media data,
the remote apparatus has a control function of outputting the media data such that the device outputs the video or the audio,
the system transmits a request signal from the user terminal to the remote apparatus via the communication network,
the remote apparatus causes the device to output the video or the audio having the pattern, the remote apparatus having received the request signal,
the user terminal detects a change in the video or the audio having the pattern that is output from the device, and
the system measures a time from when the user terminal transmits the request signal to when the user terminal detects the change, and
measures a delay in the device by using the measured time.

4. The system according to claim 2,
wherein the system measures a delay in the device by subtracting a delay time in the communication network from the measured time.

5. A method for a system including a remote apparatus connected to a device that executes processing of outputting or receiving data of a video or an audio via a communication network and a user terminal that transmits and receives a signal to and from the remote apparatus via the communication network, the method comprising:
performing, in the device and the remote apparatus, processing of outputting or receiving a video or an audio having a predetermined pattern;
detecting, in the user terminal or the remote apparatus, outputting or receiving of the video or the audio having the pattern; and
calculating a delay time in the device by setting a timing at which outputting or receiving of the video or the audio having the pattern is detected as a reference and using timings at which the device and the remote apparatus transmit the data of the video or the audio having the pattern via the communication network.

6. (canceled)

7. A program for a system including a remote apparatus connected to a device that executes processing of outputting or receiving data of a video or an audio via a communication network and a user terminal that transmits and receives a signal to and from the remote apparatus via the communication network,
the program causing a computer to function as the user terminal and to execute steps comprising:
performing, in the device and the remote apparatus, processing of outputting or receiving a video or an audio having a predetermined pattern; and
calculating, in a case where outputting or receiving of the video or the audio having the pattern is detected in the user terminal or the remote apparatus,
a delay time in the device by setting a timing at which outputting or receiving of the video or the audio having the pattern is detected as a reference and using timings at which the device and the remote apparatus transmit the data of the video or the audio having the pattern via the communication network.
